(19) United States
(12) Patent Application Publication
(10) Pub. No.: US 2025/0350385 A1
(43) Pub. Date: Nov. 13, 2025

(54) DEVICE AND METHOD FOR CONFIGURING ANTENNA USING PHASE OF ANTENNA

(71) Applicant: HL KLEMOVE CORPORATION, Incheon (KR)

(72) Inventor: Ji Hyeon LEE, Incheon (KR)

(21) Appl. No.: 18/914,965

(22) Filed: Oct. 14, 2024

(30) Foreign Application Priority Data
May 10, 2024 (KR) 10-2024-0062073

(51) Int. Cl. H04B 17/391; H01Q 3/26; H01Q 3/30; H04W 16/18

(52) U.S. Cl. CPC H04B 17/3912; H01Q 3/2664; H01Q 3/30; H04W 16/18

(57) ABSTRACT

The disclosure relates to a technology for configuring an antenna using a phase of an antenna, and provides an antenna configuration device and method comprising generating a virtual antenna between antennas included in a plurality of antennas positioned within a preset first distance from a first antenna, determining a phase difference between the antennas included in the plurality of antennas, determining a reliability indicating a performance of the virtual antenna based on the phase difference, and removing at least one antenna among the plurality of antennas based on the reliability, and installing an extrapolated antenna within a preset second distance from an unremoved antenna among the plurality of antennas.

### CROSS-REFERENCE TO RELATED APPLICATION

This application claims priority from Korean Patent Application No. 10-2024-0062073, filed on May 10, 2024, which is hereby incorporated by reference for all purposes as if fully set forth herein.

### BACKGROUND

### Technical Field

The disclosure relates to a technology for configuring an antenna using the phase of the antenna.

### Description of Related Art

In a driving environment of a vehicle, a radar detects various objects through transmission/reception of signals. The radar may include an antenna for transmitting/receiving signals, a radome, which is a dome-shaped structure designed to protect the radar from strong winds, etc., a waveguide through which transmitted/received signals move, an indicator that indicates radar information, signal intensity etc. at plane coordinates, a transmitter, a receiver, etc., as its structures.

The radar may provide information such as the distance from the radar to the object the angle of a specific portion of the object or the moving speed of the object by transmitting a signal and measuring a signal reflected by the object.

If many antennas are installed, the detection accuracy of the radar, i.e., the accuracy of information that may be obtained from the radar, may be increased. However, enhancing radar performance by simply increasing the number of antennas may suffer from increased antenna installation costs and poor radar efficiency relative to the number of antennas installed.

### BRIEF SUMMARY

The disclosure provides a technology for configuring an antenna using the phase of an antenna.

In an aspect, the present embodiments provide an antenna configuration device for configuring an antenna using a phase of an antenna, comprising a virtual antenna generator generating a virtual antenna between antennas included in a plurality of antennas positioned within a preset first distance from a first antenna, an antenna remover determining a phase difference between the antennas included in the plurality of antennas, determining a reliability indicating a performance of the virtual antenna based on the phase difference, and removing at least one antenna among the plurality of antennas based on the reliability, and an extrapolated antenna installer installing an extrapolated antenna within a preset second distance from an unremoved antenna among the plurality of antennas.

In another aspect, the present embodiments provide an antenna configuration method for configuring an antenna using a phase of an antenna, comprising generating a virtual antenna between antennas included in a plurality of antennas positioned within a preset first distance from a first antenna, determining a phase difference between the antennas included in the plurality of antennas, determining a reliability indicating a performance of the virtual antenna based on the phase difference, and removing at least one antenna among the plurality of antennas based on the reliability, and installing an extrapolated antenna within a preset second distance from an unremoved antenna among the plurality of antennas.

The disclosure may provide a technology for configuring an antenna using the phase of an antenna.

### BRIEF DESCRIPTION OF THE SEVERAL VIEWS OF THE DRAWINGS

The above and other objects, features, and advantages of the disclosure will be more clearly understood from the following detailed description, taken in conjunction with the accompanying drawings, in which:

FIG. 1 is a view illustrating a configuration of a device for configuring an antenna using a phase of an antenna according to an embodiment;

FIG. 2 is a flowchart illustrating a process of configuring an antenna using a phase of an antenna according to an embodiment;

FIG. 3 is an example view illustrating an arrangement state of an antenna according to an embodiment;

FIG. 4 is a view illustrating a virtual antenna generated around an antenna according to an embodiment;

FIG. 5 is an example view illustrating a reliability of a virtual antenna determined based on a phase difference of an antenna according to an embodiment;

FIG. 6 is another example view illustrating a reliability of a virtual antenna determined based on a phase difference of an antenna according to an embodiment;

FIG. 7 is an example view illustrating a criterion for excluding an antenna based on a reliability of a virtual antenna according to an embodiment;

FIG. 8 is another example view illustrating a criterion for excluding an antenna based on a reliability of a virtual antenna according to an embodiment;

FIG. 9 is a view illustrating an extrapolated antenna installed around an antenna according to an embodiment;

FIG. 10 is a flowchart illustrating an example in which an extrapolated antenna is installed according to an embodiment; and

FIG. 11 is a flowchart illustrating a method for configuring an antenna using a phase of an antenna according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, embodiments are described in detail with reference to the accompanying drawings.

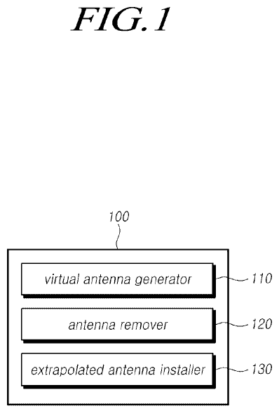

FIG. 1 is a view illustrating a configuration of a device for configuring an antenna using a phase of an antenna according to an embodiment;

Referring to FIG. 1, a device 100 for configuring an antenna using a phase of the antenna includes a virtual antenna generator 110 for generating a virtual antenna between antennas included in a plurality of antennas positioned within a predetermined first distance from a first antenna.

Phase may mean the angle of the first start point of one period of a repeated waveform or the position at any one moment. The unit of the phase is radian or degree (°). In the disclosure, the phase may be referred to as a phase angle.

Each antenna may have a phase, and a phase difference may occur between antennas. A phase difference may also occur even between antennas having the same period and amplitude. There is proposed a method in which the antenna configuration device of the disclosure 110 generates a virtual antenna using the phase of each antenna, remove at least one antenna with poor performance using the phase difference from the adjacent antenna, and install an extrapolated antenna extended from an existing antenna with respect to a non-removed antenna, thereby increasing the radar performance using fewer antennas.

In the disclosure, the first antenna may be referred to as a center antenna.

For example, the plurality of antennas may be positioned a third distance away from the top, bottom, left, and right sides of the first antenna.

The plurality of antennas of the disclosure may be arranged in various ways. The antenna arrangement schemes include a non-uniform linear array (NLA) antenna arrangement scheme in which antennas are arranged at a predetermined interval ratio and a uniform linear array (ULA) antenna arrangement scheme in which antennas are arranged at the same interval ratio.

Specifically, the NLA antenna arrangement scheme is a scheme in which N antennas (where Nis an integer of 2 or more) are arranged at various distances, and the ULA antenna arrangement scheme is a scheme in which N antennas are arranged at the same distance. In the disclosure, a plurality of antennas arranged according to an NLA antenna arrangement scheme may be referred to as an NLA antenna, and a plurality of antennas arranged according to an ULA antenna arrangement scheme may be referred to as a ULA antenna.

As an example of the NLA antenna, four antennas may be arranged in a row, and the distances of the antennas may be arranged at a ratio of 2:3:4:1. Alternatively, the antennas may be arranged to have distances of 22, 32, 42, and 2.

Further, as an example of the ULA antenna, three antennas may be arranged in a row, and the distance of the antennas may be arranged at a ratio of 1:1:1. Alternatively, the antennas may be arranged to have distances of 2, 2, and 2.

Further, the NLA antenna and the ULA antenna may be arranged to cross each other, the NLA antenna and the NLA antenna may be arranged to cross each other, or the ULA antenna and the ULA antenna may be arranged to cross each other. However, the arrangement scheme for the plurality of antennas described above is merely an example, and may be arranged in various forms as necessary.

As another example, the virtual antenna may be generated a fourth distance away from two antennas included in the plurality of antennas.

The virtual antenna of the disclosure refers to an antenna temporarily generated to remove an antenna having the lowest performance among the plurality of antennas installed around the center antenna.

The antenna configuration device 110 of the disclosure aims to create a radar having good performance through installation of a small number of extrapolated antennas by generating a virtual antenna with respect to a previously installed antenna and determining the reliability of the virtual antenna based on a phase difference between antennas.

The virtual antenna may be generated at a center position of two adjacent antennas. The virtual antenna may be generated at any one position at the same distance from two adjacent antennas. Further, the antenna configuration device 100 of the disclosure may generate a virtual antenna according to a joint interpolation scheme.

The antenna configuration device 100 of the disclosure includes an antenna remover 120 that determines the phase difference between antennas included in the plurality of antennas, determines the reliability indicating the performance of the virtual antenna based on the phase difference, and removes at least one antenna among the plurality of antennas based on the reliability.

The antenna configuration device 100 of the disclosure determines a phase difference between two antennas involved in the generation of the virtual antenna, and determines the reliability of each virtual antenna based on the phase difference. The reliability of the disclosure may refer to a numerical value indicating the performance of the generated virtual antenna or the performance of a previously installed antenna. The two antennas involved in the generation of the virtual antenna having low reliability may be treated as antennas having the lowest performance, and the antennas having low performance may be removed so as not to be involved in the generation of the extrapolated antenna.

The reliability of the disclosure may be considered to be higher as the phase difference between the two antennas involved in the generation of the virtual antenna is smaller. Conversely, the larger the phase difference, the lower the reliability. Therefore, the reliability may be expressed as a reciprocal of the phase difference. However, this is merely one expression method on the grounds that the phase difference and the reliability are inversely proportional, and the reliability determination method is not limited thereto, and may be variously set as necessary.

For example, when there is one virtual antenna having the lowest reliability, the antenna remover 120 of the disclosure may remove two antennas involved in the generation of the virtual antenna having the lowest reliability.

As another example, when there are two or more virtual antennas having the lowest reliability, the antenna remover 120 of the disclosure may remove an antenna commonly included among antennas involved in the generation of each virtual antenna having the lowest reliability.

As another example, when there is one virtual antenna having the lowest reliability, the antenna remover 120 of the disclosure may compare the phases of the antennas involved in the generation of the reliability of each virtual antenna having the lowest reliability and select and remove any one of the two antennas.

As another example, when there are two or more virtual antennas having the lowest reliability, the antenna remover 120 of the disclosure may remove all antennas involved in the generation of each virtual antenna having the lowest reliability.

The number of virtual antennas having low reliability and the number of antennas to be removed are not limited to the above-described numbers, and may be variously set as necessary.

The antenna remover 120 of the disclosure may remove all of the virtual antennas after removing at least one of the plurality of antennas.

Since the virtual antenna is an unreal antenna and is for removing an antenna that interferes with enhancing radar performance, the virtual antenna is also removed when the antenna removal is completed.

As another example, the reliability may be inversely proportional to the phase difference between two antennas.

The device 100 for configuring the antenna using the phase of the antenna includes an extrapolated antenna installer 130 for installing an extrapolated antenna within a predetermined second distance from an antenna that is not removed among the plurality of antennas.

For example, the extrapolated antenna may be installed within the preset second distance from the unremoved antenna.

The distance between the unremoved antenna and the extrapolated antenna may be the same as the distance between the center antenna and the unremoved antenna. By installing the extrapolated antenna at a predetermined distance from the unremoved antenna, the radar may detect a wider range and more precisely.

As another example, the structure formed by the plurality of antennas including the extrapolated antenna may include at least one of a ULA antenna structure and an NLA antenna structure.

The plurality of antennas including the extrapolated antenna may have a ULA antenna structure in which antennas at various distances are arranged in a row, or an NLA antenna structure in which antennas at the same distance are arranged in a row. The plurality of antennas may also have a cross-shaped antenna structure in which the ULA antennas and NLA antennas are arranged together. However, the arrangement of the antennas is not limited to the case where the antennas are arranged in a row or in a cross shape, but may have any other various structures that may generate a virtual antenna according to the above-described conditions and determine the reliability according to the phase difference between antennas to thereby remove some antennas and may generate an extrapolated antenna to enhance the radar performance.

The antenna configuration device 100 of the disclosure may generate a virtual antenna between adjacent antennas, remove antennas having poor performance according to the reliability of the virtual antenna, and install an extrapolated antenna based on remaining unremoved antennas to thereby provide performance including an enhanced angular resolution than other radars having the same number of antennas and may also enhance the performance of poor-performance radars through the method of the disclosure.

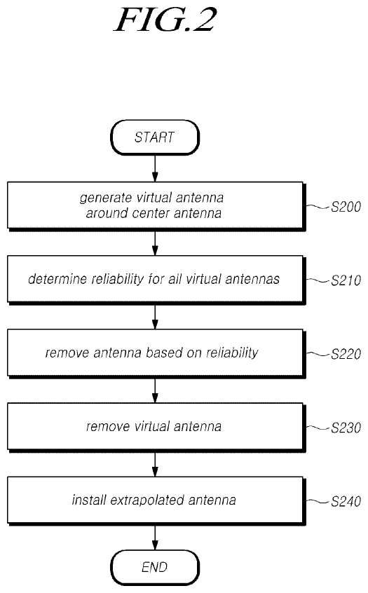

A process of configuring an antenna using a phase of an antenna according to an embodiment is described below in detail with reference to FIG. 2.

FIG. 2 is a flowchart illustrating a process of configuring an antenna using a phase of an antenna according to an embodiment;

Referring to FIG. 2, a process in which an antenna configuration device of the disclosure configures an antenna using a phase may be performed as follows.

Specifically, the antenna configuration device of the disclosure generates a virtual antenna around the center antenna (S200).

The center antenna may refer to an antenna arranged in the center of a plurality of antennas. However, the center antenna may be variously set according to the arrangement of the plurality of antennas.

For example, when the phases of the antenna X2 and the antenna X3 positioned within a set first distance from the antenna X1, which is the center antenna, are ØX2 and ØX3, respectively, a virtual antenna may be generated based on the phase difference between the antenna X2 and the antenna X3 with respect to the antenna X1.

The phase difference between the antenna X2 and the antenna X3 may be determined by Equation 1.

$${e}^{j {ϕ}_{X 23}} = {e}^{j {ϕ}_{X 2}} * conj ( {e}^{j {ϕ}_{X 3}} ) \qquad ( Equation 1 )$$

(e^{jϕx23} means the phase difference between the antenna X2 and the antenna X3,
e^{jϕx2} means the phase of the antenna X2, and means the phase of the antenna X3)

The antenna configuration device of the disclosure may generate a virtual antenna between two adjacent antennas.

The virtual antenna generated between the antenna X2 and the antenna X3 may be an antenna positioned at the same distance as the antenna X2 and the antenna X3. In the disclosure, the antenna X2 and the antenna X3 may be referred to as antennas involved in the generation of the virtual antenna.

If the virtual antenna is generated, the antenna configuration device of the disclosure determines the reliability of all of the virtual antennas based on the phase difference of the antenna according to Equation 1 (S210).

The virtual antenna is for removing an antenna having the lowest performance among the installed antennas, and the antenna configuration device of the disclosure determines the reliability of the performance of the antenna for all of the virtual antennas.

The reliability determination method may be variously set, but it is proposed that the reliability of the disclosure is determined as a reciprocal of the phase difference between two antennas involved in the generation of a virtual antenna. For example, if the phase difference between the antenna X2 and the antenna X3 is 10, the reliability of the virtual antenna generated between the antenna X2 and the antenna X3 is 1/10.

If the reliability of all of the virtual antennas is determined, the antenna configuration device of the disclosure removes at least one antenna based on the reliability (S220).

When reliability of all of the virtual antennas is determined, the antenna configuration device of the disclosure selects a virtual antenna having low reliability and removes at least one antenna involved in virtual antenna generation. Removing the antenna means turning off the power of the antenna or allowing it not to be involved in installing an added extrapolated antenna, rather than physically removing the antenna.

The number of virtual antennas having low reliability and the number of antennas to be removed are not limited to one, and may be variously determined as necessary.

For example, if the number of virtual antennas having low reliability is one, the number of antennas to be removed may be one or two, and if the number of virtual antennas having low reliability is two, the number of antennas to be removed may be one to four. The selection criterion for the antenna to be removed may be to remove the antenna having the largest phase, to remove the duplicatedly involved antenna among the antennas involved in virtual antenna generation, or to remove all of the of the antennas involved in virtual antenna generation having low reliability.

If at least one antenna is removed based on the reliability, the antenna configuration device of the disclosure removes all of the virtual antennas (S230).

As described above, since the virtual antenna is a virtual object generated to remove a low-performance antenna, if the antenna removal is completed, the virtual antenna is also removed.

If all of the virtual antennas are removed, the antenna configuration device of the disclosure installs an extrapolated antenna around the unremoved antenna (S240).

The antenna configuration device of the disclosure installs an extrapolated antenna around each antenna based on an unremoved antenna. Installing an extrapolated antenna may not only mean physically installing the antenna but also mean installing another virtual antenna as necessary.

The distance between the unremoved antenna and the extrapolated antenna may be equal to the distance between the center antenna and the unremoved antenna.

For example, if the distance between the center antenna and the unremoved antenna is λ, the distance between the unremoved antenna and the extrapolated antenna may also be set to λ. However, this is merely an example, and the distance between the unremoved antenna and the extrapolated antenna may be variously set according to the use of the radar, such as 22 and 32.

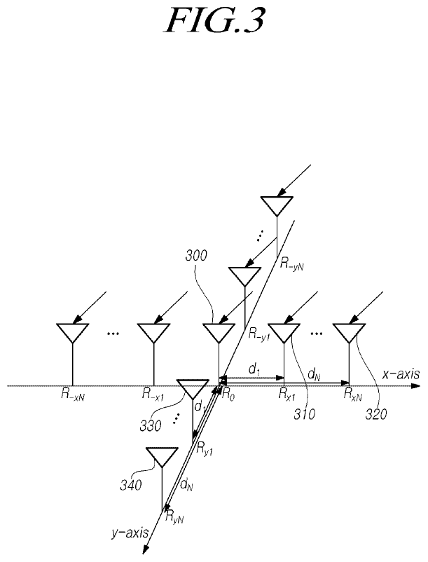

FIG. 3 is an example view illustrating an arrangement state of an antenna according to an embodiment;

Referring to FIG. 3, a plurality of antennas of the disclosure may be arranged in various ways. As described above, the antenna arrangement schemes may include an NLA antenna arrangement scheme in which antennas are arranged according to a predetermined ratio of inter-antenna distances, and a ULA antenna arrangement scheme in which antennas are arranged at the same inter-antenna distance.

For example, in the plurality of antennas, four ULA antennas may be arranged to be orthogonal to each other.

Referring to FIG. 3, one ULA antenna may include a center antenna 300. In the positive direction of the x-axis with respect to the center antenna RO 300, a total of N antennas from the antenna Rx1 310 disposed at the distance d1 from the center antenna RO 300 to the Nth antenna RXN 320 from the antenna RX1 310, each, may be arranged at the distance d1 (where N is an integer of two or more).

Further, for the other ULA antenna, in the positive direction of the y-axis with respect to the center antenna RO 300, a total of N antennas from the antenna Ry1 330 disposed at the distance d1 from the center antenna RO 300 to the Nth antenna RyN 340 from the antenna Ry1 330, each, may be arranged at the distance d1.

Likewise, a total of four ULA antennas, one in the negative direction of the x-axis and one each in the negative direction of the y-axis, may be arranged in a cross shape.

The arrangement scheme of the plurality of antennas is not limited thereto, and may be set in various ways as necessary. ULA antennas may be arranged together, NLA antennas may be arranged together, or ULA antennas and NLA antennas may be mixed. Antennas may be arranged in various shapes rather than cross shapes.

The antenna configuration device of the disclosure may generate a virtual antenna between a plurality of antennas arranged as described above, and install an extrapolated antenna in at least one antenna based on the reliability of the generated virtual antenna, thereby enhancing the performance of the radar.

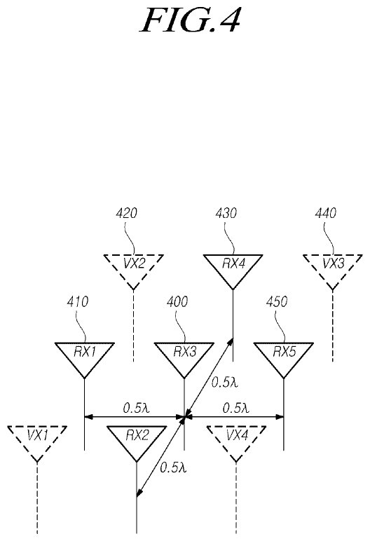

FIG. 4 is a view illustrating a virtual antenna generated around an antenna according to an embodiment.

Referring to FIG. 4, in a structure in which antennas RX1, RX2, RX3, and RX5 each are arranged at a distance of 0.52 from the antenna RX3 400 with respect to the center antenna RX3 400, virtual antennas VX1, VX2, VX3, and VX4 may be generated between the antennas.

In the disclosure, one center antenna and four surrounding antennas are arranged in a cross shape for convenience of description, but this is merely an example, and the number and arrangement of antennas may be set in various ways as necessary.

For example, the virtual antenna VX2 420 may be generated based on a phase difference between the antenna RX1 410 and the antenna RX3 400 with respect to the antenna RX4 430. Alternatively, the virtual antenna VX2 420 may be expressed as being generated based on a phase difference between the antenna RX3 400 and the antenna RX4 430 with respect to the antenna RX1 410.

To determine reliability, the phase of the virtual antenna is determined based on the phase difference between a reference satellite involved in the generation of the virtual antenna and two satellites. Based on the above-described example, it may be expressed as Equation 2.

$${e}^{j {ϕ}_{VX 2}} = {e}^{j {ϕ}_{RX 1}} * {e}^{j {ϕ}_{RX 34}} = {e}^{j {ϕ}_{RX 4}} * conj ( {e}^{j {ϕ}_{RX 31}} ) \qquad ( Equation 2 )$$

(e^{jϕVX2} means the phase of the virtual antenna VX2 420, e^{jϕRX1} means the phase of RX1 410, and e^{jϕRX34} means the phase difference between RX3 and RX4.)
e^{jϕRX1}*e^{jϕRX34} which may be represented as
e^{jϕRX4}*conj(e^{jϕRX31}).

As another example, the virtual antenna VX3 440 may be generated based on a phase difference between the RX3 400 and the RX5 450 with respect to the RX4 430. Alternatively, the VX3 440 may be expressed as being generated based on the phase difference between the RX3 400 and the RX4 430 with respect to the RX5 450.

As another example, the virtual antenna VX2 420 of the disclosure may be positioned at the same distance as the antenna RX1 410 and the antenna RX4 430, and the line connecting the virtual antenna VX2 420 and the antenna RX1 410 may be perpendicular to the line connecting the RX1 410 and the antenna RX3 400. Further, the line connecting the virtual antenna VX2 420 and the antenna RX4 430 may be perpendicular to the line connecting the RX4 430 and the antenna RX3 400.

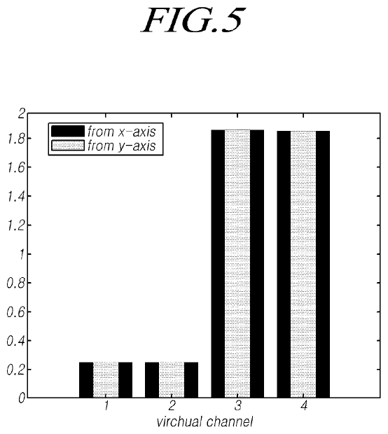

FIG. 5 is an example view illustrating a reliability of a virtual antenna determined based on a phase difference of an antenna according to an embodiment;

Referring to FIG. 5, if a virtual antenna is generated between antennas as shown in FIG. 4, the antenna configuration device of the disclosure may determine the reliability of the virtual antenna based on the phase difference between the two antennas involved in the generation of the virtual antenna.

Specifically, the antenna configuration device of the disclosure may determine the reliability of the virtual antenna as a reciprocal of the phase difference. If there are two phase differences between the two antennas involved in the generation of the virtual antenna, the antenna configuration device of the disclosure may determine the reliability as a reciprocal of the average of the two phase differences.

As described above, since the phase difference and the reliability are inversely proportional, the larger phase difference determined means that the lower reliability. The low reliability of the virtual antenna means that there is an antenna having low performance among the antennas involved in the generation of the virtual antenna.

Referring to FIG. 5, the x-axis of the graph denotes the number of the virtual antenna, and the y-axis denotes the phase of the antenna involved in the generation of the virtual antenna. Further, the black y-axis information refers to the phase of one antenna related to virtual antenna generation, and the gray y-axis information refers to the phase of another antenna related to virtual antenna generation. Further, a difference between the black y-axis information and the gray y-axis information may be a phase difference.

For example, in the virtual antennas VX1, VX2, VX3, and VX4 of FIG. 4, the virtual antennas VX1 and VX2 indicate that the phase differences for the phases of the antennas involved in the generation of each of the virtual antennas VX1 to VX4 are all the same in light of the fact that the black numerical value and the gray numerical value are the same on the y-axis of the graph and the black numerical value and the gray numerical value are the same on the y-axis of the graph. It means that the reliabilities for VX1 to VX4 are the same.

In this case, it means that there is no antenna having a particularly low performance, and the antenna configuration device of the disclosure may install an extrapolated antenna for all of the antennas without excluding a specific antenna.

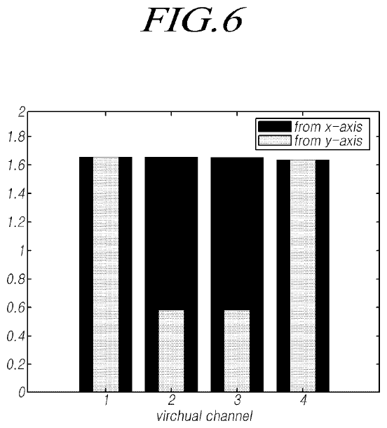

FIG. 6 is another example view illustrating a reliability of a virtual antenna determined based on a phase difference of an antenna according to an embodiment;

Referring to FIG. 6, the x-axis of the graph denotes the number of the virtual antenna, and the y-axis denotes the phase difference between antennas involved in the generation of the virtual antenna. Further, the black y-axis information refers to the phase of one antenna related to virtual antenna generation, and the gray y-axis information refers to the phase of another antenna related to virtual antenna generation.

For example, in light that, for the virtual antennas VX1 and VX4, the black numerical value and the gray numerical value on the y-axis of the graph are the same but, for the virtual antennas VX2 and VX3, the black numerical value and the gray numerical value on the y-axis are different from each other, it means that the phase difference between VX1 and VX4 is smaller than the phase difference between VX2 and VX3, and thus the reliability of the virtual antennas VX1 and VX4 is higher than the reliability of VX2 and VX3.

In this case, a common antenna among the antennas involved in the generation of the virtual antennas VX2 and VX3 having low reliability may be deleted. Referring to FIGS. 4 and 6, the antenna commonly involved in the generation of virtual antennas VX2 and VX3 is RX4. Therefore, an extrapolated antenna may be installed with respect to an antenna other than RX4.

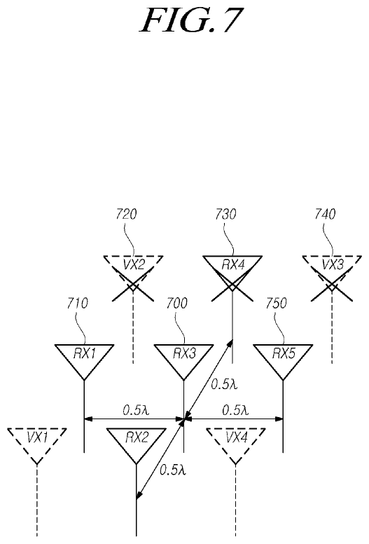

FIG. 7 is an example view illustrating a criterion for excluding an antenna based on a reliability of a virtual antenna according to an embodiment;

Referring to FIG. 7, the antenna configuration device of the disclosure may determine the reliability based on a phase difference between antennas involved in generation of each virtual antenna, and remove antennas commonly included in generation of two virtual antennas having low reliability.

Removing the antenna means powering off the antenna or excluding the antenna while installing an extrapolated antenna, rather than physically removing the antenna.

Specifically, according to FIG. 7, when the virtual antennas having low reliability are VX2 720 and VX3 740, the RX4 730 commonly involved in forming the virtual antenna may be removed except for the center antenna 700. The antenna configuration device of the disclosure may regard the RX4 730 as an antenna having low performance and exclude the RX4 730 from being involved in an antenna in which an extrapolated antenna is installed.

Further, the virtual antennas VX2 720 and VX3 740, which are determined to have low reliability, may be simultaneously removed at the time when the antenna RX4 730 is removed. However, the time of removal of the virtual antenna may be the same as the time of removal of the antenna involved in the generation of the virtual antenna having low reliability, or it may be removed together with the remaining virtual antennas after the antenna involved in the generation of the virtual antenna having low reliability is removed.

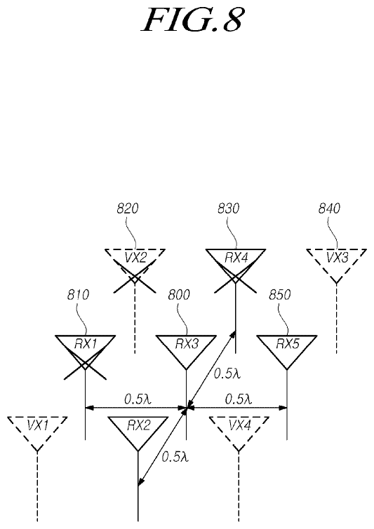

FIG. 8 is another example view illustrating a criterion for excluding an antenna based on a reliability of a virtual antenna according to an embodiment;

Referring to FIG. 8, the antenna configuration device of the disclosure determines the reliability based on a phase difference between antennas involved in generation of each virtual antenna, and if there is one virtual antenna having low reliability, removes the antenna involved in generation of one virtual antenna.

For example, when the virtual antenna having low reliability is the VX2 820, the RX1 810 and the RX4 830 involved in forming the virtual antenna may be removed except for the center antenna 800. The antenna configuration device of the disclosure may regard the RX1 810 and the RX4 830 as antennas having low performance, and may exclude them from being involved in an antenna in which an extrapolated antenna is installed.

Further, the virtual antenna VX2 820 having low reliability may be removed at the time when the RX1 810 and the RX4 830 are removed. However, the time of removal of the virtual antenna may be the same as the time of removal of the antenna involved in the generation of the virtual antenna having low reliability, or it may be removed together with the remaining virtual antennas after the antenna involved in the generation of the virtual antenna having low reliability is removed.

As another example, when the virtual antenna having low reliability is the VX3 840, the RX4 830 and the RX5 850 involved in forming the virtual antenna other than the center antenna 800 may be removed. The antenna configuration device of the disclosure may regard the RX4 830 and the RX5 850 as antennas having low performance, and may exclude them from being involved in an antenna in which an extrapolated antenna is installed.

Further, the virtual antenna VX3 840 having low reliability may be removed at the time when the RX4 830 and the RX5 850 are removed. As described above, the time of removal of the virtual antenna may be the same as the time of removal of the antenna involved in the generation of the virtual antenna having low reliability, or it may be removed together with the remaining virtual antennas after the antenna involved in the generation of the virtual antenna having low reliability is removed.

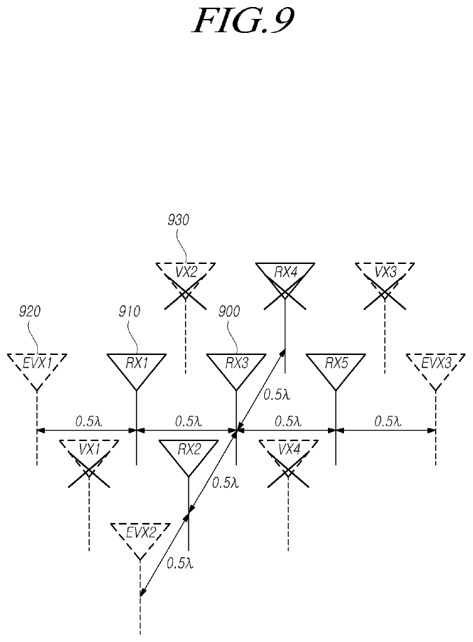

FIG. 9 is a view illustrating an extrapolated antenna installed around an antenna according to an embodiment;

Referring to FIG. 9, the antenna configuration device of the disclosure may remove an antenna involved in the generation of a virtual antenna having low reliability based on the reliability of the virtual antenna, and may install an extrapolated antenna with respect to the unremoved antenna.

Specifically, if the reliability of the virtual antenna is determined, the antenna configuration device of the disclosure may remove at least one antenna involved in the generation of the virtual antenna having low reliability, remove all of the of the virtual antennas, and then install an extrapolated antenna with respect to the unremoved antenna.

The antenna configuration device of the disclosure may remove RX4 commonly involved in forming antennas VX2 and VX3 having low reliability. RX4 may be treated as a low-performance antenna.

The antenna configuration device of the disclosure may remove all of the virtual antennas VX1, VX2, VX3, and VX4 if the low-performance antenna RX4 is removed. If all of the virtual antennas are removed, extrapolated antennas may be installed around the unremoved antennas RX1, RX2, and RX5. As described above, since the extrapolated antenna is to enhance the performance of the radar based on the extended distance in the conventional antenna arrangement, it is proposed to install it toward the outside of the existing antenna with respect to the center antenna.

The distance between the unremoved antenna and the extrapolated antenna may be equal to the distance between the center antenna and the unremoved antenna. For example, the extrapolated antenna EVX1 920 installed with respect to the antenna RX1 910 may be installed at a distance of 0.52, which is the same distance between the antenna RX1 910 and the center antenna RX3 900 and the antenna RX1 910. As such, the extrapolation of the antenna increases the size of the antenna aperture, and the performance including the angular resolution of the radar is increased as the antenna with low performance is excluded.

However, since this is an example, the distance between the unremoved antenna and the extrapolated antenna may be variously set as necessary.

The extrapolated antenna to be installed also has a phase. For example, for the EVX1 920 which is an extrapolated antenna installed at a position symmetrical to the RX3 900 with respect to the RX1 910, the phase of the extrapolated antenna EVX1 920 may be expressed as Equation 3.

$${e}^{j {ϕ}_{EVX 1}} = {e}^{j {ϕ}_{RX 1}} * {e}^{j {ϕ}_{RX 31}} \qquad ( Equation 3 )$$

(e^{jϕEVX1} means the phase of the extrapolated antenna EVX1, e^{jϕRX1} means the phase of the antenna RX1, and e^{jϕRX31} means the phase difference between the antennas RX1 and RX3.)

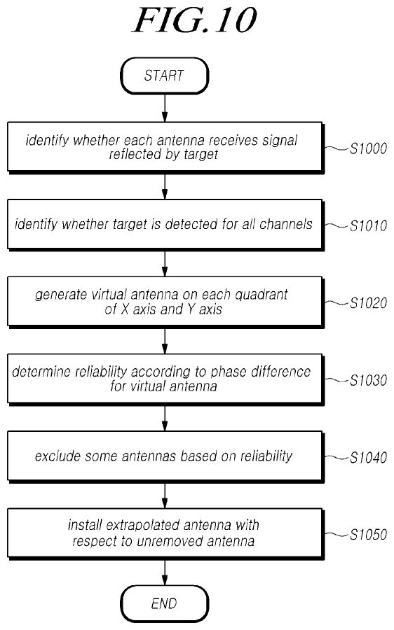

FIG. 10 is a flowchart illustrating an example in which an extrapolated antenna is installed according to an embodiment.

Referring to FIG. 10, the antenna configuration device of the disclosure may install an extrapolated antenna around some antennas based on the reliability of the virtual antenna.

Specifically, the antenna configuration device of the disclosure identifies whether the antenna related to the radar receives a signal reflected from the target (S1000). This is a process for identifying whether the antenna is an activated antenna.

If it is identified that the signal reflected by the target is received, the antenna configuration device of the disclosure identifies whether the target is detected for all of the channels (S1010).

Each antenna may detect the target by performing 2demensions-fast Fourier transform (2D-FFT) on all of the channels and performing cellaverage-constant false alarm rate (CA-CFAR) determination. In this regard, the antenna configuration device of the disclosure may identify whether each antenna detects the target.

If it is identified whether the target is detected for all of the channels, the antenna configuration device of the disclosure generates a virtual antenna between the antennas (S1020).

The arrangement scheme for the plurality of antennas may be set in various ways, but the disclosure may include a cross-shape arrangement including at least one ULA antenna or at least one NLA antenna. In the orthogonal form, some antennas may be referred to as an X-axis, and other antennas may be referred to as a Y-axis.

A virtual antenna may be generated between two adjacent antennas, and the virtual antenna may be positioned at the same distance as the two antennas involved in the generation.

If the virtual antenna is generated, the antenna configuration device of the disclosure determines the reliability of the virtual antenna (S1030).

The reliability is for selecting a low-performance antenna from among antennas involved in the generation of the virtual antenna, and may be determined as a reciprocal of the phase difference between the antennas involved in the generation of the virtual antenna.

If the reliability of the virtual antenna is determined, the antenna configuration device of the disclosure excludes at least one of the antennas involved in virtual antenna generation from the antennas involved in installing the extrapolated antenna with respect to the virtual antenna having low reliability (S1040).

If antenna exclusion is completed, the antenna configuration device removes the virtual antenna and installs an extrapolated antenna with respect to the remaining unremoved antennas (S1050).

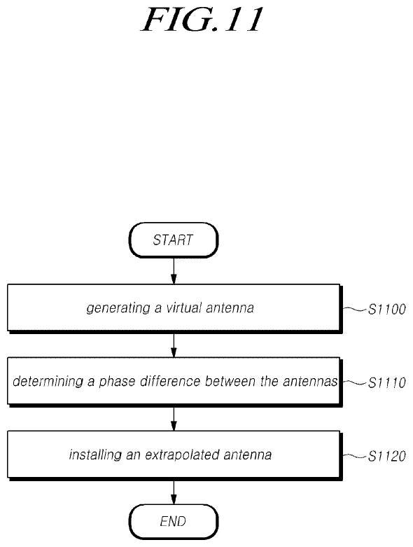

FIG. 11 is a flowchart illustrating a method for configuring an antenna using a phase of an antenna according to an embodiment.

Referring to FIG. 11, a method for configuring an antenna using a phase of the antenna includes generating a virtual antenna between antennas included in a plurality of antennas positioned within a predetermined first distance from a first antenna (S1100).

Each antenna may have a phase, and a phase difference may occur between antennas. A phase difference may also occur even between antennas having the same period and amplitude. There is proposed a method in which the antenna configuration device of the disclosure configures a virtual antenna using the phase of each antenna, remove at least one antenna with poor performance using the phase difference from the adjacent antenna, and install an extrapolated antenna extended from an existing antenna with respect to a non-removed antenna, thereby increasing the radar performance using fewer antennas.

In the disclosure, the first antenna may be referred to as a center antenna.

For example, the plurality of antennas may be positioned a third distance away from the top, bottom, left, and right sides of the first antenna.

The plurality of antennas of the disclosure may be arranged in various ways. The antenna arrangement schemes include a non-uniform linear array (NLA) antenna arrangement scheme in which antennas are arranged at a predetermined interval ratio and a uniform linear array (ULA) antenna arrangement scheme in which antennas are arranged at the same interval ratio.

Specifically, the NLA antenna arrangement scheme is a scheme in which N antennas (where Nis an integer of 2 or more) are arranged at various distances, and the ULA antenna arrangement scheme is a scheme in which N antennas are arranged at the same distance. In the disclosure, a plurality of antennas arranged according to an NLA antenna arrangement scheme may be referred to as an NLA antenna, and a plurality of antennas arranged according to an ULA antenna arrangement scheme may be referred to as a ULA antenna.

As an example of the NLA antenna, four antennas may be arranged in a row, and the distances of the antennas may be arranged at a ratio of 2:3:4:1. Alternatively, the antennas may be arranged to have distances of 22, 32, 42, and 2.

Further, as an example of the ULA antenna, three antennas may be arranged in a row, and the distance of the antennas may be arranged at a ratio of 1:1:1. Alternatively, the antennas may be arranged to have distances of 2, 2, and 2.

Further, the NLA antenna and the ULA antenna may be arranged to cross each other, the NLA antenna and the NLA antenna may be arranged to cross each other, or the ULA antenna and the ULA antenna may be arranged to cross each other. However, the arrangement scheme for the plurality of antennas described above is merely an example, and may be arranged in various forms as necessary.

As another example, the virtual antenna may be generated a fourth distance away from two antennas included in the plurality of antennas.

The virtual antenna of the disclosure refers to an antenna temporarily generated to remove an antenna having the lowest performance among the plurality of antennas installed around the center antenna.

The antenna configuration device of the disclosure aims to create a radar having good performance through installation of a small number of extrapolated antennas by generating a virtual antenna with respect to a previously installed antenna and determining the reliability of the virtual antenna based on a phase difference between antennas.

The virtual antenna may be generated at a center position of two adjacent antennas. In the disclosure, the two adjacent antennas may mean two antennas positioned within a set first distance. The virtual antenna may be generated at any one position at the same distance from two adjacent antennas.

The antenna configuring method includes determining the phase difference between antennas included in the plurality of antennas, determining the reliability indicating the performance of the virtual antenna based on the phase difference, and removes at least one antenna among the plurality of antennas based on the reliability (S1110).

The antenna configuration device of the disclosure determines a phase difference between two antennas involved in the generation of the virtual antenna, and determines the reliability of each virtual antenna based on the phase difference. The reliability of the disclosure may refer to a numerical value indicating the performance of the generated virtual antenna or the performance of a previously installed antenna. The two antennas involved in the generation of the virtual antenna having low reliability may be treated as antennas having the lowest performance, and the antennas having low performance may be removed so as not to be involved in the generation of the extrapolated antenna.

The reliability of the disclosure may be considered to be higher as the phase difference between the two antennas involved in the generation of the virtual antenna is smaller. Conversely, the larger the phase difference, the lower the reliability. Therefore, the reliability may be expressed as a reciprocal of the phase difference. However, this is merely one expression method on the grounds that the phase difference and the reliability are inversely proportional, and the reliability determination method is not limited thereto, and may be variously set as necessary.

For example, when there is one virtual antenna having the lowest reliability, removing at least one antenna of the disclosure may remove two antennas involved in the generation of the virtual antenna having the lowest reliability.

As another example, when there are two or more virtual antennas having the lowest reliability, removing at least one antenna of the disclosure may remove an antenna commonly included among antennas involved in the generation of each virtual antenna having the lowest reliability.

As another example, when there is one virtual antenna having the lowest reliability, removing at least one antenna of the disclosure may compare the phases of the antennas involved in the generation of the reliability of each virtual antenna having the lowest reliability and select and remove any one of the two antennas.

As another example, when there are two or more virtual antennas having the lowest reliability, removing at least one antenna of the disclosure may remove all antennas involved in the generation of each virtual antenna having the lowest reliability.

The number of virtual antennas having low reliability and the number of antennas to be removed are not limited to the above-described numbers, and may be variously set as necessary.

Removing at least one antenna of the disclosure may remove all of the virtual antennas after removing at least one of the plurality of antennas.

Since the virtual antenna is an unreal antenna and is for removing an antenna that interferes with enhancing radar performance, the virtual antenna is also removed when the antenna removal is completed.

As another example, the reliability may be inversely proportional to the phase difference between two antennas.

The method for configuring the antenna using the phase of the antenna includes installing an extrapolated antenna within a predetermined second distance from an antenna that is not removed among the plurality of antennas (S1120).

For example, the extrapolated antenna may be installed within the preset second distance from the unremoved antenna.

The distance between the unremoved antenna and the extrapolated antenna may be the same as the distance between the center antenna and the unremoved antenna. By installing the extrapolated antenna at a predetermined distance from the unremoved antenna, the radar may detect a wider range and more precisely.

As another example, the structure formed by the plurality of antennas including the extrapolated antenna may include at least one of a uniform linear array (ULA) antenna structure and a non-uniform linear array (NLA) antenna structure.

The plurality of antennas including the extrapolated antenna may have a ULA antenna structure in which antennas at various distances are arranged in a row, or an NLA antenna structure in which antennas at the same distance are arranged in a row. The plurality of antennas may also have a cross-shaped antenna structure in which the ULA antennas and NLA antennas are arranged together. However, the arrangement of the antennas is not limited to the case where the antennas are arranged in a row or in a cross shape, but may have any other various structures that may generate a virtual antenna according to the above-described conditions and determine the reliability according to the phase difference between antennas to thereby remove some antennas and may generate an extrapolated antenna to enhance the radar performance.

As a radar with enhanced performance is built by utilizing a relatively small number of antennas through the operations of the above-described steps, the detection performance of the radar may be increased.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

1. An antenna configuration device, comprising:
a virtual antenna generator generating a virtual antenna between antennas included in a plurality of antennas positioned within a preset first distance from a first antenna;
an antenna remover determining a phase difference between the antennas included in the plurality of antennas, determining a reliability indicating a performance of the virtual antenna based on the phase difference, and removing at least one antenna among the plurality of antennas based on the reliability; and
an extrapolated antenna installer installing an extrapolated antenna within a preset second distance from an unremoved antenna among the plurality of antennas.

2. The antenna configuration device of claim 1, wherein the plurality of antennas are positioned a third distance away from the first antenna in an upper, lower, left, or right direction of the first antenna.

3. The antenna configuration device of claim 2, wherein the virtual antenna is generated a fourth distance away from two antennas included in the plurality of antennas.

4. The antenna configuration device of claim 3, wherein when there is one virtual antenna having the lowest reliability, the antenna remover removes two antennas involved in generation of the virtual antenna having the lowest reliability.

5. The antenna configuration device of claim 4, wherein when there are two or more virtual antennas having the lowest reliability, the antenna remover removes an antenna commonly included among antennas involved in generation of the respective virtual antennas having the lowest reliability.

6. The antenna configuration device of claim 1, wherein the antenna remover removes all virtual antennas after removing at least one antenna among the plurality of antennas.

7. The antenna configuration device of claim 1, wherein the reliability is inversely proportional to the phase difference.

8. The antenna configuration device of claim 1, wherein a distance between an unremoved antenna among the plurality of antennas and the extrapolated antenna is identical to a distance from the first antenna to the unremoved antenna.

9. The antenna configuration device of claim 1, wherein a structure formed by the plurality of antennas including the extrapolated antenna includes at least one of a uniform linear array (ULA) antenna structure and a non-uniform linear array (NLA) antenna structure.

10. An antenna configuration method, comprising:
generating a virtual antenna between antennas included in a plurality of antennas positioned within a preset first distance from a first antenna;
determining a phase difference between the antennas included in the plurality of antennas, determining a reliability indicating a performance of the virtual antenna based on the phase difference, and removing at least one antenna among the plurality of antennas based on the reliability; and
installing an extrapolated antenna within a preset second distance from an unremoved antenna among the plurality of antennas.

11. The antenna configuration method of claim 10, wherein the plurality of antennas are positioned a third distance away from the first antenna in an upper, lower, left, or right direction of the first antenna.

12. The antenna configuration method of claim 11, wherein the virtual antenna is generated a fourth distance away from two antennas included in the plurality of antennas.

13. The antenna configuration method of claim 12, wherein when there is one virtual antenna having the lowest reliability, removing at least one antenna removes two antennas involved in generation of the virtual antenna having the lowest reliability.

14. The antenna configuration method of claim 13, wherein when there are two or more virtual antennas having the lowest reliability, removing at least one antenna removes an antenna commonly included among antennas involved in generation of the virtual antennas having the lowest reliability.

15. The antenna configuration method of claim 10, wherein removing at least one antenna removes all virtual antennas after removing at least one antenna among the plurality of antennas.

16. The antenna configuration method of claim 10, wherein the reliability is inversely proportional to the phase difference.

17. The antenna configuration method of claim 10, wherein a distance between an unremoved antenna among the plurality of antennas and the extrapolated antenna is identical to a distance from the first antenna to the unremoved antenna.

18. The antenna configuration method of claim 10, wherein a structure formed by the plurality of antennas including the extrapolated antenna includes at least one of a uniform linear array (ULA) antenna structure and a non-uniform linear array (NLA) antenna structure.
